(19) United States
(12) Patent Application Publication
(10) Pub. No.: US 2014/0069685 A1
(43) Pub. Date: Mar. 13, 2014

(54) FLUORINE-CONTAINING ELASTOMER COMPOSITION AND INSULATED WIRE

(71) Applicant: HITACHI CABLE, LTD., Tokyo (JP)

(72) Inventor: Masanobu Nakahashi, Tokyo (JP)

(73) Assignee: Hitachi Cable, Ltd., Tokyo (JP)

(21) Appl. No.: 13/752,184

(22) Filed: Jan. 28, 2013

(30) Foreign Application Priority Data
Sep. 12, 2012 (JP) 2012-200386

(51) Int. Cl. C08L 27/18; H01B 3/42

(52) U.S. Cl. CPC C08L 27/18; H01B 3/427
USPC 174/110 SR; 526/250; 524/546

(57) ABSTRACT

A fluorine-containing elastomer composition includes a fluorine-containing resin including a copolymer of tetrafluoroethylene and α-olefin having carbon number of 2 to 4. The copolymer of tetrafluoroethylene and α-olefin having carbon number of 2 to 4 is configured such that a peak integrated value of −132 ppm relative to a peak integrated value 10,000 of −110 to −125 ppm falls within the range of 0.3 to 2.0 in nuclear magnetic resonance analysis.

The present application is based on Japanese patent application No. 2012-200386 filed on Sep. 12, 2011, the entire contents of which are incorporated herein by reference.

### BACKGROUND OF THE INVENTION

1. Field of the Invention

This invention relates to a fluorine-containing elastomer composition and an insulated wire using the composition. In particular, this invention relates to a fluorine-containing elastomer composition that is, for example, capable of forming an insulator having heat resistance and that has mass productivity, as well as an insulated wire including a conductor and an insulating layer that is formed by covering the outer periphery of the conductor with the fluorine-containing elastomer composition and causing the fluorine-containing elastomer composition to be cross-linked.

2. Description of the Related Art

It is known that as an insulator for an insulated wire, a copolymer of tetrafluoroethylene and α-olefin having carbon number of 2 to 4, in particular, a tetrafluoroethylene-propylene based copolymer is used (for example, refer to JP-A-S58-057209). In addition, an insulator is known, the insulator being configured such that unsaturated bonds are introduced thereinto as cross-linking portions for the purpose of further improving mechanical strength and heat resistance (for example, JP-A-S59-230030)). The insulator is excellent in heat resistance, oil resistance, chemical resistance and electric characteristics, thus it is expected to be applied to a covering material such as a hose, a tube, a gasket, a packing, a diaphragm, a sheet, the above-mentioned insulating layer for the insulated wire.

### SUMMARY OF THE INVENTION

However, there is a problem that for example, a product that uses an insulator into which unsaturated bonds are introduced as a covering material causes variation in characteristics (in particular, tensile characteristic and heat resistance), thus it is difficult to provide a product that is stable in characteristics, consequently some products that do not satisfy characteristic as a finished product are included, so that a product yield is lowered and a product having mass productivity cannot be provided.

Accordingly, it is an object of the invention to provide a fluorine-containing elastomer composition that is capable of forming an insulator having excellent mechanical characteristics (in particular, tensile characteristic) and heat resistance and that has mass productivity, as well as an insulated wire including a conductor and an insulating layer that is formed by covering the outer periphery of the conductor with the fluorine-containing elastomer composition, and allowing the fluorine-containing elastomer composition to be cross-linked.

(1) According to one embodiment of the invention, a fluorine-containing elastomer composition comprises:

a fluorine-containing resin comprising a copolymer of tetrafluoroethylene and α-olefin having carbon number of 2 to 4,

wherein the copolymer of tetrafluoroethylene and α-olefin having carbon number of 2 to 4 is configured such that a peak integrated value of −132 ppm relative to a peak integrated value 10,000 of −110 to −125 ppm falls within the range of 0.3 to 2.0 in nuclear magnetic resonance analysis.

In the above embodiment (1) of the invention, the following modifications and changes can be made.

(i) The fluorine-containing resin further contains at least one of a cross-linking agent, an auxiliary cross-linking agent and an acid acceptor as an additive agent.

(ii) The copolymer of tetrafluoroethylene and α-olefin having carbon number of 2 to 4 comprises a tetrafluoroethylene-propylene based copolymer.

(2) According to another embodiment of the invention, an insulated wire comprises: a conductor; and

an insulating layer that is formed by covering the outer periphery of the conductor with the fluorine-containing elastomer composition according to the embodiment (1) and causing the fluorine-containing elastomer composition to be cross-linked.

### Effects of the Invention

According to one embodiment of the invention, a fluorine-containing elastomer composition can be provided that is capable of forming an insulator having excellent mechanical characteristics (in particular, tensile characteristic) and heat resistance and that has mass productivity, as well as an insulated wire including a conductor and an insulating layer that is formed by covering the outer periphery of the conductor with the fluorine-containing elastomer composition, and allowing the fluorine-containing elastomer composition to be cross-linked.

Further, with regard to the mass productivity, conventionally an introduction amount of the unsaturated bonds does not become constant dependent on raw materials so as to be varied, thus it is impossible to specify the introduction amount of the unsaturated bonds in a manufacturing stage, and characteristics of the insulator cannot be understood until the product is manufactured (for example, until a kneading by a roll is carried out), consequently a product that uses the above-mentioned insulator as a covering material causes variation in characteristics (in particular, tensile characteristic and heat resistance), thus it is difficult to provide a product that is stable in characteristics, consequently some products that do not satisfy characteristic as a finished product are included, so that a product yield is lowered and a product having mass productivity cannot be provided. Namely, conventionally, the introduction amount of the unsaturated bonds is not known for certain, and the finished product has a variation in characteristics, so that the variation in characteristics has an influence on product yield (mass productivity). However, in the present invention, the introduction amount of the unsaturated bonds is preliminarily measured, and only the raw materials that satisfy the characteristics of the finished product are selected so as to be used, thus in particular, in case of long products such as an electric wire, a cable, the variation in characteristics is small throughout the longitudinal direction, so that the yield can be enhanced. Accordingly, a product having mass productivity can be provided

### DETAILED DESCRIPTION OF THE PREFERRED EMBODIMENTS

### Summary of Embodiments

The fluorine-containing elastomer composition according to the embodiment includes a fluorine-containing resin, wherein the fluorine-containing resin comprises a copolymer of tetrafluoroethylene and α-olefin having carbon number of 2 to 4, wherein the copolymer of tetrafluoroethylene and α-olefin having carbon number of 2 to 4 is configured such that a peak integrated value of −132 ppm relative to a peak integrated value 10,000 of −110 to −125 ppm falls within the range of 0.3 to 2.0 in nuclear magnetic resonance analysis.

In addition, an insulated wire according to the embodiment includes a conductor and an insulating layer that is formed by covering the outer periphery of the conductor with the above-mentioned fluorine-containing elastomer composition, and allowing the fluorine-containing elastomer composition to be cross-linked.

### Embodiment

### Fluorine-Containing Elastomer Composition

The fluorine-containing elastomer composition according to the embodiment includes a fluorine-containing resin, wherein the fluorine-containing resin comprises a copolymer of tetrafluoroethylene and α-olefin having carbon number of 2 to 4, wherein the copolymer of tetrafluoroethylene and α-olefin having carbon number of 2 to 4 is configured such that a peak integrated value of −132 ppm relative to a peak integrated value 10,000 of −110 to −125 ppm falls within the range of 0.3 to 2.0 in nuclear magnetic resonance analysis.

As the α-olefin having carbon number of 2 to 4 that constitutes the copolymer included in the fluorine-containing resin, and that copolymerizes with tetrafluoroethylene so as to exhibit elastomeric properties, any one of propylene and butene-1 can be used individually, and at least two selected from the group consisting of ethylene, propylene, butene-1 and isobutene can be used in combination, but it is preferred to use propylene in terms of achieving the object of the present invention.

Consequently, in the embodiment, it is preferable that the copolymer of tetrafluoroethylene and α-olefin having carbon number of 2 to 4 is a tetrafluoroethylene-propylene based copolymer.

As the tetrafluoroethylene-propylene based copolymer, a copolymer can be used, the copolymer appropriately including components that are capable of being copolymerized with tetrafluoroethylene and propylene as main components in addition to tetrafluoroethylene and propylene. As the components copolymerizable with tetrafluoroethylene and propylene, for example, ethylene, isobutylene, acrylic acid and alkyl ester thereof, vinyl fluoride, vinylidene fluoride, hexafluoropropene, chloroethylvinylether, chlorotrifluoroethylene, perfluoroalkylvinylether and the like can be used.

It is preferable that the tetrafluoroethylene-propylene based copolymer is configured such that the content molar ratio (tetrafluoroethylene/propylene) of tetrafluoroethylene and propylene is selected from a range of 95/5 to 30/70, and it is more preferable that the content molar ratio is selected from a range of 90/10 to 45/55. In addition, it is preferable that the content of the components except for the main components is selected from a range of not more than 50 mole %, in particular, not more than 30 mole % in terms of heat resistance, formability and the like.

It is preferable that the tetrafluoroethylene-propylene based copolymer is configured to have a number average molecular weight of 20,000 to 200,000 in terms of extrusion property and mechanical strength, if the number average molecular weight is more than 200,000, cracks easily occurs in the formed product, on the other hand, if less than 20,000, mechanical strength is likely to be insufficient. Adjustment of the number average molecular weight in these cases can be carried out by a method of directly adjusting a molecular weight of the produced polymer due to operations of the copolymerization reaction condition such as a monomer concentration, a polymerization initiator concentration, an amount ratio of monomer and polymerization initiator, a polymerization temperature, a use of chain transfer agent, or a method of producing a copolymer having a high molecular weight at the time of the copolymerization reaction, and then allowing it to have a low molecular weight by for example, applying heat treatment thereto in the presence of oxygen.

In the embodiment, an amount of the unsaturated bonds of the copolymer of tetrafluoroethylene and α-olefin having carbon number of 2 to 4, for example, the tetrafluoroethylene-propylene based copolymer is measured by using a nuclear magnetic resonance analysis device. A peak integrated value of −110 to −125 ppm in which a peak appears, the peak being derived from portions except for the unsaturated bonds of the tetrafluoroethylene-propylene based copolymer is determined as 10,000, and a peak integrated value of −132 ppm that is derived from the unsaturated bonds relative to the peak integrated value of −110 to −125 ppm is obtained, so that the value obtained is determined as the amount of the unsaturated bonds.

In the embodiment, a copolymer of tetrafluoroethylene and α-olefin having carbon number of 2 to 4 is used, the copolymer being configured such that a peak integrated value of −132 ppm relative to a peak integrated value 10,000 of −110 to −125 ppm falls within the range of 0.3 to 2.0 in nuclear magnetic resonance analysis. If the peak integrated value of −132 ppm is less than 0.3, heat resistance is lowered, and if more than 2.0, mechanical strength and heat resistance are lowered.

In the embodiment, for the purpose of developing rubber elasticity, it is preferable that the fluorine-containing resin further contains at least one of a cross-linking agent such as an organic peroxide, an auxiliary cross-linking agent and an acid acceptor such as magnesium oxide as an additive agent. In the embodiment, for the purpose of heightening a cross-linking reaction property, an auxiliary cross-linking agent is added thereto. As the auxiliary cross-linking agent, for example, an allyl type compound such as triallylisocyanurate, triallylcyanurate, triallyltrimellitate, tetraallylpyromellitate can be used.

In the embodiment, various additive agents such as an inorganic filler, a stabilizer, an antioxidant, a plasticizer, a lubricant other than the above-mentioned components can be appropriately added.

### Insulated Wire

The insulated wire is configured to include a conductor formed of, for example, a generalized tin plating copper twisted wire or the like and an insulating layer that is formed by covering the outer periphery of the conductor with the above-mentioned fluorine-containing elastomer composition and allowing the fluorine-containing elastomer composition to be cross-linked.

### EXAMPLES

Hereinafter, the fluorine-containing elastomer composition and the insulated wire according to the present invention will be explained more particularly by using Examples. Further, the present invention is not subject to any restrictions due to Examples described below.

### Example 1

A tetrafluoroethylene-propylene based copolymer as the copolymer of tetrafluoroethylene and α-olefin having carbon number of 2 to 4 (manufactured by Asahi Glass Co., Ltd. and sold by the trade name of AFLAS, an amount of unsaturated bonds: 0.3, a measurement method of the amount of unsaturated bonds will be explained below) 100 g, an organic peroxide (α, α′-di(tert-butylperoxide diisopropylbenzene) as a cross-linking agent (manufactured by Nippon Oil & Fats Co., Ltd. and sold by the trade name of Perbutyl P) 2 g, an allyl-type compound (triallylisocyanurate) as an auxiliary cross-linking agent 5 g, magnesium oxide as an acid acceptor 1 g, anhydrous silicic acid as a filler 10 g and barium stearate as a lubricant 1 g were kneaded by using rolls. The compound obtained was extruded and covered on a conductor having an outer diameter of 16 mm formed of a tin plating copper twisted wire so as to have a thickness of 0.3 mm by using a 40 mm extruder (L/D=22) of which temperature was set to a predetermined temperature (die: 100 degrees C., head: 80 degrees C., cylinder 1: 80 degrees C., cylinder 2: 80 degrees C.), and then a cross-linking was applied thereto by steam of 13 kgf/cm² for 3 minutes so as to obtain an insulated wire.

Further, an amount of the unsaturated bonds of the tetrafluoroethylene-propylene based copolymer was measured by using a nuclear magnetic resonance analysis device (manufactured by Japan Electro Optical Laboratory Ltd. and sold by the trade name of ECA-500FT-NM). A peak integrated value of 410 to 425 ppm in which a peak appears, the peak being derived from portions except for the unsaturated bonds of the tetrafluoroethylene-propylene based copolymer was determined as 10,000, and a peak integrated value of −132 ppm that was derived from the unsaturated bonds relative to the peak integrated value of −110 to −125 ppm was obtained, so that the value obtained was determined as the amount of the unsaturated bonds.

### Examples 2 to 4 and Comparative Examples 1 to 2

Insulated wires were obtained by carrying out similarly to Example 1 except that amounts of the components were varied as shown in Table 1.

The tin plating copper twisted wire was drawn out from the insulated wire manufactured as shown above so as to form a tubular shape, and tensile characteristic and heat resistance of each sample were measured. The evaluation result is shown in Table 1.

TABLE 1
(mixed amount unit: parts by mass)

| | | | | Sample | | | | | |
|---|---|---|---|---|---|---|---|---|---|
| | | | | Example | | | | Comparative Example | |
| Item | | | | 1 | 2 | 3 | 4 | 1 | 2 |
| Fluorine- | Tetrafluoroethylene- | Amount of | 0.1 | | | | | 100 | |
| containing | propylene based | unsaturated | 0.3 | 100 | | | | | |
| resin | copolymer (*1) | bonds | 1.0 | | 100 | | | | |
| | | | 1.5 | | | 100 | | | |
| | | | 2.0 | | | | 100 | | |
| | | | 2.2 | | | | | | 100 |

| | | | | | | | | |
|---|---|---|---|---|---|---|---|---|
| | Cross-linking agent | Organic peroxide (*2) | 2 | 2 | 2 | 2 | 2 | 2 |
| | Auxiliary | Allyl-type compound | 5 | 5 | 5 | 5 | 5 | 5 |
| | cross-linking agent | (*3) | | | | | | |
| | Acid acceptor | Magnesium oxide | 1 | 1 | 1 | 1 | 1 | 1 |
| | Filler | Anhydrous silicic acid | 10 | 10 | 10 | 10 | 10 | 10 |
| | Lubricant | Barium stearate | 1 | 1 | 1 | 1 | 1 | 1 |
| Evaluation | Tensile characteristic | Tensile strength (MPa) | 22.1 | 20.3 | 18.5 | 16.1 | 23.0 | 12.2 |
| | | Target: not less than 13 | | | | | | |
| | | Elongation (%) | 400 | 380 | 360 | 350 | 410 | 280 |
| | | Target: not less than 300 | | | | | | |
| | Heat resistance | Percentage of retention | 85 | 98 | 104 | 110 | 68 | 88 |
| | | of tensile strength (%) | | | | | | |
| | | Target: not less than 80 | | | | | | |
| | | Percentage of retention | 110 | 102 | 96 | 90 | 106 | 70 |
| | | (%) of elongation | | | | | | |
| | | Target: not less than 80 | | | | | | |

(*1) Tetrafluoroethylene-propylene based copolymer: manufactured by Asahi Glass Co., Ltd. and sold by the trade name of AFLAS
(*2) Organic peroxide: α,α′-di(tert-butylperoxide diisopropylbenzene) manufactured by Nippon Oil & Fats Co., Ltd. and sold by the trade name of Perbutyl P)
(*3) Allyl-type compound: triallylisocyanurate

Heat resistance was evaluated such that samples were placed in a heat aging testing machine for 4 days and were taken out therefrom so as to measure tensile characteristic after heat aging, and a ratio of tensile characteristic after heat aging to initial tensile characteristic was calculated by the following formula in which the ratio is represented as percentage of retention (%), and if the percentage of retention is not less than 80%, it is determined as acceptable.

Percentage of retention (%)=(tensile characteristic after heat aging/initial tensile characteristic)×100

As shown in Table 1, any of Examples 1 to 4 that falls within a scope of the present invention exhibits high tensile characteristic and heat resistance. On the other hand, Comparative Example 1 that is corresponding to a case that the amount of the unsaturated bonds is less than the lower limit of the range described in the present invention is insufficient in heat resistance. In addition, Comparative Example 2 that is corresponding to a case that the amount of the unsaturated bonds is more than the lower limit of the range described in the present invention is insufficient in both of tensile characteristic and heat resistance.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A fluorine-containing elastomer composition, comprising:
a fluorine-containing resin comprising a copolymer of tetrafluoroethylene and α-olefin having carbon number of 2 to 4,
wherein the copolymer of tetrafluoroethylene and α-olefin having carbon number of 2 to 4 is configured such that a peak integrated value of −132 ppm relative to a peak integrated value 10,000 of −110 to −125 ppm falls within the range of 0.3 to 2.0 in nuclear magnetic resonance analysis.

2. The fluorine-containing elastomer composition according to claim 1, wherein the fluorine-containing resin further contains at least one of a cross-linking agent, an auxiliary cross-linking agent and an acid acceptor as an additive agent.

3. The fluorine-containing elastomer composition according to claim 1, wherein the copolymer of tetrafluoroethylene and α-olefin having carbon number of 2 to 4 comprises a tetrafluoroethylene-propylene based copolymer.

4. An insulated wire, comprising:
a conductor; and
an insulating layer that is formed by covering the outer periphery of the conductor with the fluorine-containing elastomer composition according to claim 1 and causing the fluorine-containing elastomer composition to be cross-linked.
